(19) United States
(12) Patent Application Publication
(10) Pub. No.: US 2021/0377293 A1
(43) Pub. Date: Dec. 2, 2021

(54) TESTING ASSISTANCE DEVICE, TESTING ASSISTANCE METHOD, AND TESTING ASSISTANCE PROGRAM

(71) Applicant: NIPPON TELEGRAPH AND TELEPHONE CORPORATION, Chiyoda-ku, Tokyo (JP)

(72) Inventors: Kaku TAKEUCHI, Musashino-shi, Tokyo (JP); Satoshi KUBOTA, Musashino-shi, Tokyo (JP)

(73) Assignee: NIPPON TELEGRAPH AND TELEPHONE CORPORATION, Chiyoda-ku, Tokyo (JP)

(21) Appl. No.: 17/290,817

(22) PCT Filed: Oct. 23, 2019
(86) PCT No.: PCT/JP2019/041556

§ 371 Date: May 3, 2021

(30) Foreign Application Priority Data
Nov. 5, 2018 (JP) 2018-208271

(51) Int. Cl. H04L 29/06; H04L 12/26

(52) U.S. Cl. CPC H04L 63/1433; H04L 43/50

(57) ABSTRACT

An inspection assistance device for assisting in security inspection for examining security of the inspection section includes: an input unit that acquires device information of each of a plurality of devices that can communicate with each other; an inspection section condition database unit that stores condition data that defines at least one of a starting point condition which is a condition of the device serving as the starting point and an ending point condition which is a condition of the device serving as the ending point; and an inspection section search unit that compares the device information acquired by the input unit with the condition data stored in the inspection section condition database unit to extract one or more combinations of a first device serving as the starting point and a second device serving as the ending point from the plurality of devices.

### TECHNICAL FIELD

The present invention relates to an inspection assistance device, an inspection assistance method, and an inspection assistance program.

### BACKGROUND ART

Finding out security problems of a network system and taking countermeasures is important in safe operation of the network system. Various security inspection methods for finding out such a security problem are known. PTL 1 discloses a method of correlating a transmission packet to a target device with a response packet for the transmission packet and examining vulnerability of the target device.

Many security inspection software products are used broadly and practically. For example, software such as ping that examines the communication with an ICMP protocol with respect to devices of an inspection target network system is known. “ICMP” is an abbreviation of Internet Control Message Protocol. In addition to this, software such as Nmap that performs port scanning with respect to devices to examine an attackable open port is known. “Nmap” is an abbreviation of Network Mapper. In addition to this, software such as OpenVAS and OWASP ZAP that examines the possibility of pseudo-attack with such a message that exploits known vulnerability is known. “OpenVAS” is an abbreviation of Open Vulnerability Assessment System. “OWASP ZAP” is an abbreviation of OWASP Zed Attack Proxy. “OWASP” is an abbreviation of Open Web Application Security Project.

### CITATION LIST

### Patent Literature

[PTL 1] Japanese Patent Application Publication No. 2011-009994

### SUMMARY OF THE INVENTION

### Technical Problem

In a general security inspection service, security inspection is performed from an external Internet with respect to a public server in an inspection target network system assuming a cyber attack from the Internet.

In recent years, cases where a public server is attacked from an operator terminal infected with a virus by a targeted attack via an internal network have occurred. However, the number of routes in which a public server is likely to be attacked is expected to be enormous, considering attacks from inside as well as attacks from an external Internet. Therefore, performing security inspection with respect to all routes in which a public server is likely to be attacked is costly and waste of time.

Inspection target routes may be narrowed down to increase efficiency of security inspection, which requires special knowledge. Since the method disclosed in PTL 1 does not consider a possibility that the vulnerability examination result of a target device is different depending on whether communication to the target device is communication from an external Internet or communication from inside, the unit of inspection target is “device” rather than “route”. Therefore, the method disclosed in PTL 1 cannot be applied to narrowing down the inspection target route.

An object of the present invention is to allow users without special knowledge to narrow down a target path of security inspection.

### Means for Solving the Problem

In order to solve the problem, an inspection assistance device according to an embodiment of the present invention is an inspection assistance device that performs communication from a device serving as a starting point of an inspection section to a device serving as an ending point of the inspection section and assists in security inspection for examining security of the inspection section, the inspection assistance device including: an input unit that acquires device information of each of a plurality of devices that can communicate with each other; an inspection section condition database unit that stores condition data that defines at least one of a starting point condition which is a condition of the device serving as the starting point and an ending point condition which is a condition of the device serving as the ending point; and an inspection section search unit that compares the device information acquired by the input unit with the condition data stored in the inspection section condition database unit to extract one or more combinations of a first device serving as the starting point and a second device serving as the ending point from the plurality of devices.

In order to solve the problem, an inspection assistance method according to an embodiment of the present invention is an inspection assistance method for performing communication from a device serving as a starting point of an inspection section to a device serving as an ending point of the inspection section and assisting in security inspection for examining security of the inspection section, the inspection assistance method including: acquiring device information of each of a plurality of devices that can communicate with each other; and comparing the device information with condition data that defines at least one of a starting point condition which is a condition of the device serving as the starting point and an ending point condition which is a condition of the device serving as the ending point to extract one or more combinations of a first device serving as the starting point and a second device serving as the ending point from the plurality of devices.

In order to solve the problem, an inspection assistance program according to an embodiment of the present invention is an inspection assistance program for performing communication from a device serving as a starting point of an inspection section to a device serving as an ending point of the inspection section and assisting in security inspection for examining security of the inspection section, the inspection assistance program causing a computer to execute: acquiring device information of each of a plurality of devices that can communicate with each other; and comparing the device information with condition data that defines at least one of a starting point condition which is a condition of the device serving as the starting point and an ending point condition which is a condition of the device serving as the ending point to extract one or more combinations of a first device serving as the starting point and a second device serving as the ending point from the plurality of devices.

### Effects of the Invention

According to an embodiment of the present invention, users without special knowledge can narrow down a target path of security inspection. As a result, it is possible to perform security inspection efficiently.

### BRIEF DESCRIPTION OF DRAWINGS

FIG. 1 is a diagram illustrating an overview of an embodiment of the present invention.

FIG. 2 is a block diagram illustrating a configuration of an inspection assistance device according to an embodiment of the present invention.

FIG. 3 is a flowchart illustrating an operation of an inspection assistance device according to an embodiment of the present invention.

FIG. 4 is a table illustrating an example of device information input to an input unit of an inspection assistance device according to an embodiment of the present invention.

FIG. 5 is a table illustrating an example of condition data stored in an inspection section condition database unit of an inspection assistance device according to an embodiment of the present invention.

FIG. 6 is a flowchart illustrating an example of an operation of an inspection section search unit of an inspection assistance device according to an embodiment of the present invention.

FIG. 7 is a table illustrating an example of an inspection section extracted by an inspection section search unit of an inspection assistance device according to an embodiment of the present invention.

### DESCRIPTION OF EMBODIMENTS

Hereinafter, an embodiment of the present invention will be described with reference to the drawings.

In the drawings, the same or corresponding portions are denoted by the same reference numerals. In the description of the present embodiment, description of the same or corresponding portions will be appropriately omitted or simplified.

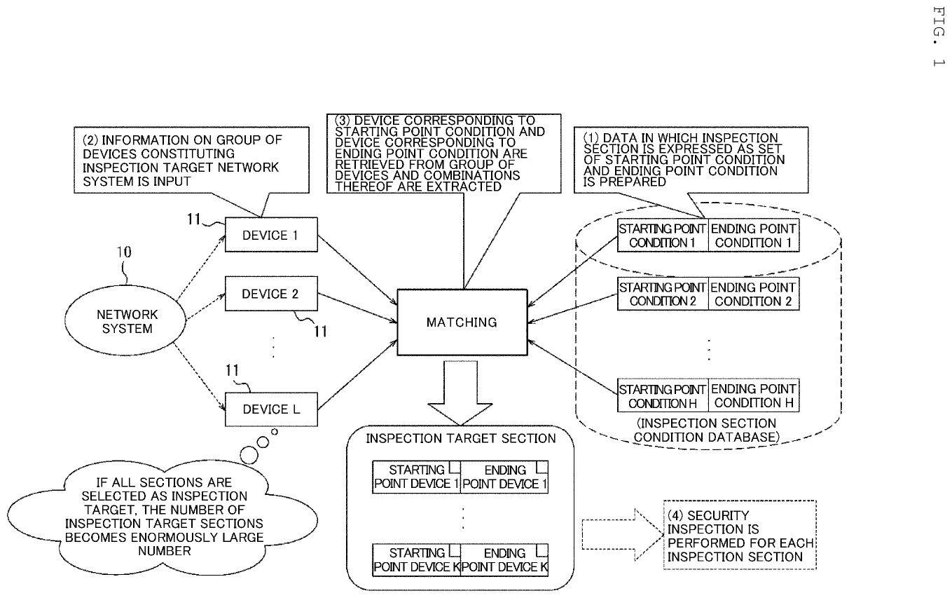

An overview of the present embodiment will be described with reference to FIG. 1.

In the present embodiment, in order to narrow down a target path of security inspection, the unit of inspection target is “section” rather than “route”. “Route” is distinguished by the combination of a starting point, a relay point, and an ending point, and “section” is distinguished by the combination of a starting point and an ending point. That is, “section” is a concept that groups a group of “routes” having a common combination of a starting point and an ending point. However, “section” has directionality. For example, a section from “device 1” to “device 2” is handled as being different from a section from “device 2” to “device 1”. Here, “device 1”, “device 2”, . . . , and “device L” illustrated in FIG. 1 are examples of devices 11 of a network system 10 serving as a target of security inspection.

The efficiency of security inspection can be increased by performing security inspection in respective sections regardless of a route in which an attack reaches from a starting point to an ending point. However, if the number of L of devices 11 of the inspection target network system 10 is large, when all sections are selected as an inspection target, the number _{L}P₂ of inspection target sections becomes an enormously large number.

Therefore, in the present embodiment, the followings are performed.

(1) Data in which an inspection section is expressed by a set of a starting point condition and an ending point condition is prepared. An inspection section is a section in which security inspection is to be performed. A starting point condition is a condition of the device 11 serving as a starting point. An ending point condition is a condition of the device 11 serving as an ending point.

(2) Information on the group of devices 11 constituting the inspection target network system 10 is input.

(3) The device 11 corresponding to the starting point condition and the device 11 corresponding to the ending point condition are retrieved from the group of devices 11, and the combinations thereof are extracted. That is, the inspection target section is narrowed down.

(4) Security inspection is performed for each inspection section.

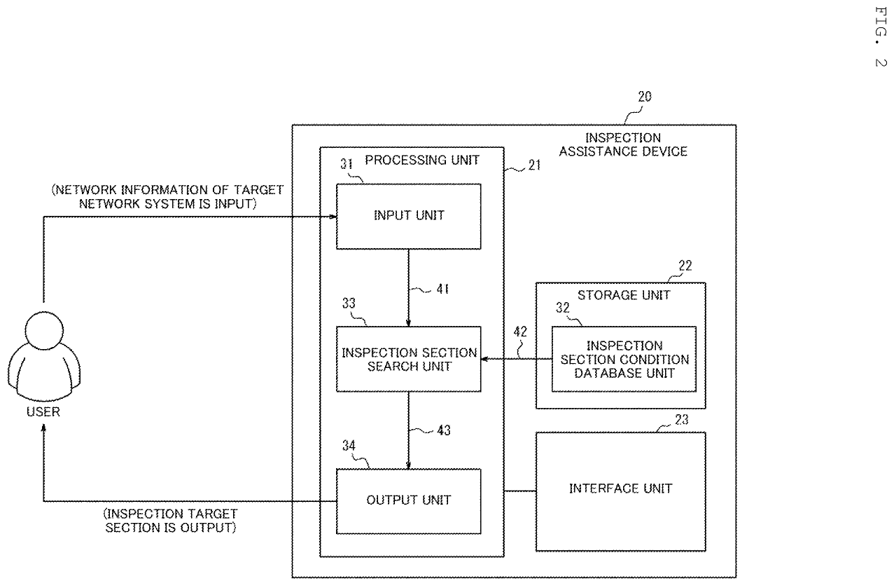

A configuration of an inspection assistance device 20 according to the present embodiment will be described with reference to FIG. 2.

The inspection assistance device 20 is one or more computers and generally includes components such as a processing unit 21, a storage unit 22, and an interface unit 23.

The processing unit 21 is one or more processors. A general-purpose processor such as CPU or a dedicated processor specialized for specific processing can be used as the processor. “CPU” is an abbreviation of Central Processing Unit. A processor is a kind of a processing circuit. The processing unit 21 controls an operation of the inspection assistance device 20.

The storage unit 22 is one or more memories. A semiconductor memory, a magnetic memory, or an optical memory, for example, can be used as the memory. The memory may function as a main storage device, an auxiliary storage device, or a cache memory. The storage unit 22 stores information used for the operation of the inspection assistance device 20 and information obtained by the operation of the inspection assistance device 20.

The interface unit 23 is a combination of one or more input interfaces and one or more output interfaces. A physical key, a capacitance key, a pointing device, or a touch screen provided integrally with a display, for example, can be used as the input interface. A display, for example, can be used as the output interface. Information used for the operation of the inspection assistance device 20 is input from users to the interface unit 23. Information obtained by the operation of the inspection assistance device 20 is output from the interface unit 23 to users.

The inspection assistance device 20 includes functional blocks including an input unit 31, an inspection section condition database unit 32, an inspection section search unit 33, and an output unit 34. When the inspection assistance device 20 is configured as a plurality of computers, one functional unit may be disposed to be divided into two or more computers, two or more functional blocks may be collectively disposed in one computer, or respective functional blocks may be disposed in separate computers.

The functions of the inspection section condition database unit 32 are realized by the storage unit 22.

The functions of the input unit 31, the inspection section search unit 33, and the output unit 34 are realized by the processing unit 21 executing a program. That is, the functions are realized by software. The processing corresponding to the functions is described by a program. When the program is executed by a computer corresponding to the inspection assistance device 20, the functions are realized on the computer. That is, the program causes the computer to execute processing corresponding to the functions. This program corresponds to an inspection assistance program according to the present embodiment.

The program can be recorded on a computer-readable recording medium. The recording medium having the program recorded thereon may be a (non-transient) non-transitory recording medium. A magnetic recording device, an optical disc, a magneto-optical recording medium, or a semiconductor memory, for example, can be used as the computer-readable recording medium. The program is distributed, for example, by selling, transferring, or lending a portable recording medium such as a DVD or a CD-ROM in which the program is recorded. “DVD” is an abbreviation of Digital Versatile Disc. “CD-ROM” is an abbreviation of Compact Disc Read Only Memory. The program may be distributed by storing the program in a storage of a server computer and transmitting the program from the server computer to another computer via a network. The program may be provided as a program product.

The computer temporarily stores, for example, the program recorded on a portable recording medium or the program transmitted from the server computer in a memory corresponding to the storage unit 22. During execution of processing, a processor corresponding to the processing unit 21 reads the program stored in the memory and executes processing according to the read program. The processor may read the program directly from the portable recording medium and execute processing according to the program. When the program is transmitted from the server computer to the computer, the processor may sequentially execute processing according to the received program. The above-described processing may be executed by a so-called ASP-type service which realizes functions by issuing an execution instruction and acquiring the results without transmitting the program from the server computer to the computer. “ASP” is an abbreviation of Application Service Provider. It is assumed that the program includes information which is provided for the processing of an electronic computer and is equivalent to a program. For example, data which has a property of defining processing of a computer which is not a direct command for a computer corresponds to that “equivalent to a program”.

The functions of the input unit 31, the inspection section search unit 33, and the output unit 34 may be realized by hardware instead of being realized by software. That is, the processing unit 21 may be one or more dedicated circuits executing processing corresponding to the respective functions. FPGA or ASIC, for example, can be used as the dedicated circuit. “FPGA” is an abbreviation of Field-Programmable Gate Array. “ASIC” is an abbreviation of Application Specific Integrated Circuit. The dedicated circuit is a kind of a processing circuit.

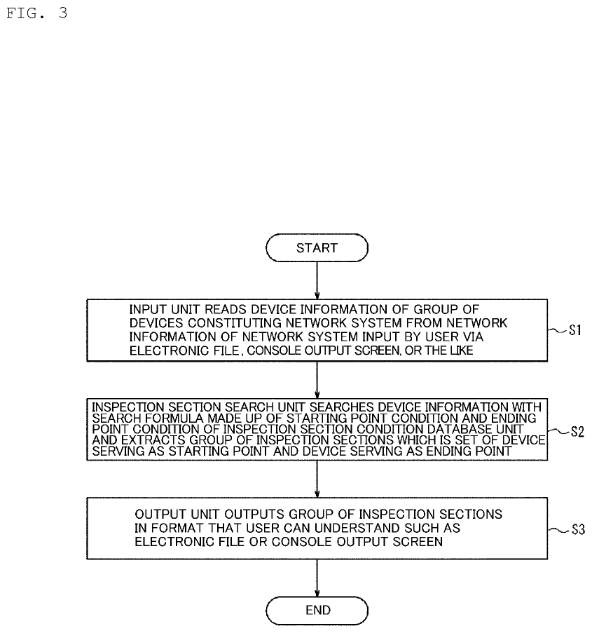

The operation of the inspection assistance device 20 according to the present embodiment will be described with reference to FIG. 3 as well as FIGS. 1 and 2. The operation of the inspection assistance device 20 corresponds to an inspection assistance method according to the present embodiment.

In step S1, the input unit 31 acquires device information 41. The device information 41 is information on each of a plurality of devices 11 that can communicate with each other.

Specifically, the input unit 31 reads the device information 41 of the group of devices 11 constituting the network system 10 from network information of the network system 10 input by the user via an electronic file, a console output screen, or the like. It is assumed that the network information explicitly or implicitly includes the device information 41 of each device 11.

In step S2, in order to perform security inspection, the inspection section search unit 33 extracts one or more combinations of the first device serving as a starting point of an inspection section and the second device serving as an ending point of an inspection section from the plurality of devices 11 on the basis of the device information 41 acquired by the input unit 31. In the security inspection, communication is performed from the device 11 serving as a starting point to the device 11 serving as an ending point to examine the security of the inspection section.

In the present embodiment, condition data 42 is stored in the inspection section condition database unit 32. The condition data 42 is data in which one or more combinations of the starting point condition and the ending point condition are defined. That is, the condition data 42 is data in which the condition of an inspection section where security inspection is performed is defined. The condition of the inspection section is made up of a set of the starting point condition indicating the condition of the device 11 serving as the starting point of inspection and the condition of the device 11 serving as the target of inspection.

The inspection section search unit 33 extracts one or more combinations of the first device and the second device from the plurality of devices 11 by comparing the device information 41 with the condition data 42 stored in the inspection section condition database unit 32.

Specifically, the inspection section search unit 33 extracts a combination of the device 11 satisfying the starting point condition and the device 11 satisfying the ending point condition from the plurality of devices 11 as at least one of the combinations of the first device and the second device. Here, the device 11 satisfying the starting point condition is the device 11 in which information such as an attribute included in the device information 41 satisfies the starting point condition included in one of the combinations defined in the condition data 42. Moreover, the device 11 satisfying the ending point condition is the device 11 in which information such as an attribute included in the device information 41 satisfies the ending point condition included in one combination defined in the condition data 42. Depending on the combination of the starting point condition and the ending point condition, there may be a case where there are two devices 11 satisfying the starting point condition and one or more devices 11 satisfying the ending point condition. Alternatively, there may be a case where there are one or more devices 11 satisfying the starting point condition and two or more devices 11 satisfying the ending point condition. In such a case, the inspection section search unit 33 extracts two or more combinations of the first device and the second device. There may be a case where there are only one device 11 satisfying the starting point condition and only one device 11 satisfying the ending point condition. In such a case, the inspection section search unit 33 extracts one combination of the first device and the second device. There may be a case where there is no device 11 satisfying the starting point condition, no device 11 satisfying the ending point condition, or both do not exist. In such a case, the inspection section search unit 33 does not extract the combination of the first device and the second device.

More specifically, the inspection section search unit 33 searches the device information 41 read in step S1 with a search formula composed of the starting point condition and the ending point condition of the inspection section condition database unit 32 and extracts a group of inspection sections which is a set of the device 11 serving as the starting point and the device 11 serving as the ending point. The extraction result 43 of the group of inspection sections extracted by the inspection section search unit 33 includes at least the device information 41 of the device 11 serving as the starting point and the device information 41 of the device 11 serving as the ending point.

In step S3, the output unit 34 outputs the group of inspection sections obtained in step S2 in a format that a user can understand such as an electronic file or a console output screen. The user performs security inspection with respect to the inspection section extracted in step S2 by referring to the output result. That is, the user performs communication from the starting point device 11 which is the first device to the ending point device 11 which is the second device to examine the vulnerability of the ending point device 11 to thereby examine the security of the corresponding inspection section for each of the combinations of the first device and the second device included in the result 43 obtained in step S2. When the vulnerability of the ending point device 11 is examined, the above-described security inspection software can be used.

A specific example of the operation of the inspection assistance device 20 will be described.

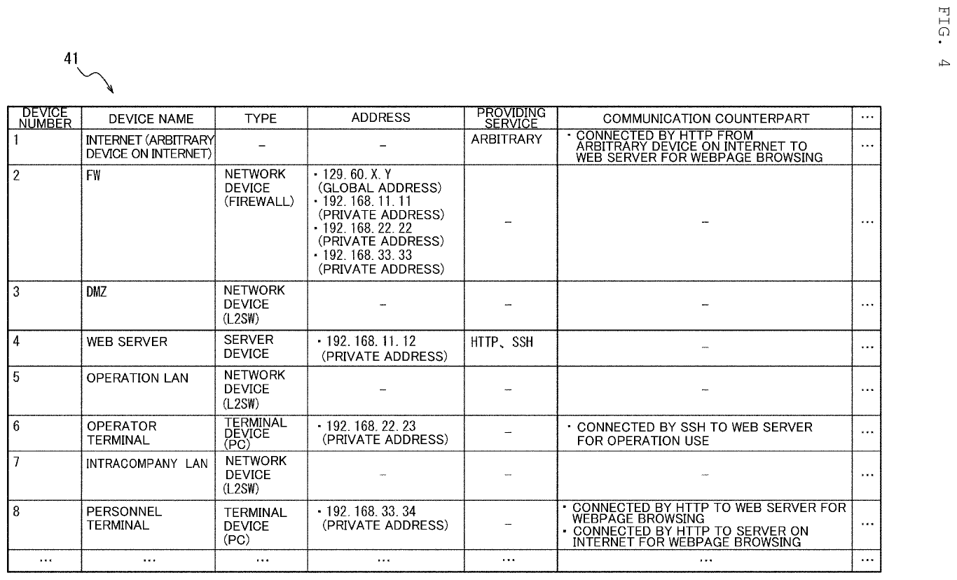

In step S1, the input unit 31 reads the device information 41 of the group of devices 11 constituting the network system 10 as illustrated in FIG. 4 from a logical network diagram of the network system 10 or a device list input by the user via an electronic file, a console output screen, or the like.

In the example of FIG. 4, the input unit 31 reads the logical network diagram of the network system 10 or the list table of the devices 11 and extracts the device information 41 of the group of devices 11 such as a terminal device, a server device, and a network device constituting the network system 10.

The read device information 41 includes identification information, type information, address information, service information, wiring information, identification information of other device 11 serving as a counterpart of communication, or the other attribute information for each of the devices 11 constituting the network system 10.

The identification information is an identifier such as the number or the name of each device 11. The type information is information indicating the type of each device 11 such as a terminal device, a server device, or a network device. The address information is information indicating a global address or a private address of each device 11, or both. The service information is information indicating a service provided by each device 11 or a protocol used for the service. The wiring information is information indicating the wiring between the devices 11.

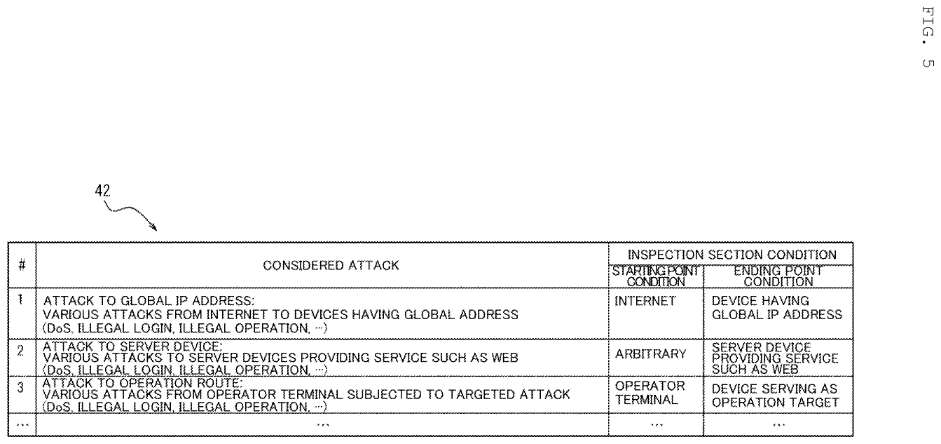

The condition of the inspection section in which security inspection is performed as illustrated in FIG. 5 is also stored in the inspection section condition database unit 32 as the condition data 42. As described above, the condition of the inspection section is made up of a set of the starting point condition indicating the condition of the device 11 serving as the starting point of inspection and the ending point condition indicating the condition of the device 11 serving as the target of inspection.

The stored condition data 42 includes the definitions of an attack to be considered in the target network system 10 and the starting point condition and the ending point condition as the condition of the section in which security inspection is to be performed against the attack to be considered.

Examples of the attack to be considered include various attacks from the Internet to the device 11 having a global IP address. “IP” is an abbreviation of Internet Protocol. In addition to this, the examples include various attacks to a server device providing a service such as a Web. In addition to this, the examples include various attacks from an operator terminal subjected to a targeted attack.

The starting point condition corresponding to an attack to the device 11 having a global IP address is a condition that the device is the device 11 connected to the Internet (that is, the device transmits a packet via the Internet). The ending point condition corresponding to an attack to the device 11 having a global IP address is a condition that the device is the device 11 having a global IP address (that is, the device has an address designated as a destination in a packet and receives a packet via the Internet). In this manner, the condition data 42 can define a combination of a condition that a device transmits a packet via the Internet and a condition that a device has an address designated as a destination in a packet and receives a packet via the Internet as one of the combinations of the starting point condition and the ending point condition. That is, the condition data 42 may define a combination of a condition that a device transmits a packet including a global IP address and a condition that a device receives a packet including the global IP address as one of the combinations of the starting point condition and the ending point condition.

The “global IP address” is an example of data and data other than “global IP address” may be designated to define a condition. That is, the condition data 42 may define a combination of a condition that a device transmits a packet including designated data and a condition that a device receives a packet including the designated data as one of the combinations of the starting point condition and the ending point condition.

The starting point condition corresponding to an attack to a server device is a condition that a device is an arbitrary device 11. The ending point condition corresponding to an attack to a server device is a condition that a device is the device 11 corresponding to the server device (that is, the device provides a service). In this manner, the condition data 42 can define a condition that a device provides a service as one of the ending point conditions.

The starting point condition corresponding to an attack from an operator terminal is a condition that a device is the device 11 corresponding to an operator terminal (that is, the device is an operator terminal). The ending point condition corresponding to an attack from an operator terminal is a condition that a device is the device 11 serving as an operation target (that is, the device is operated via an operator terminal). In this manner, the condition data 42 can define a combination of a condition that a device is an operator terminal operated by an operator and a condition that a device is operated via an operator terminal as one of the combinations of the starting point condition and the ending point condition. That is, the condition data 42 may define a combination of a condition that a device is used for operation such as server management and a condition that a device performs communication for the operation with a device used for the operation as one of the combinations of the starting point condition and the ending point condition.

The “operation” is an example of use and use other than “operation” may be designated to define the condition. That is, the condition data 42 may define a combination of a condition that a device is used for the designated use and a condition that a device performs communication for the designated use with a device used for the designated use as one of the combinations of the starting point condition and the ending point condition.

Knowhow when performing security inspection is accumulated in the inspection section condition database unit 32 in the above-described form.

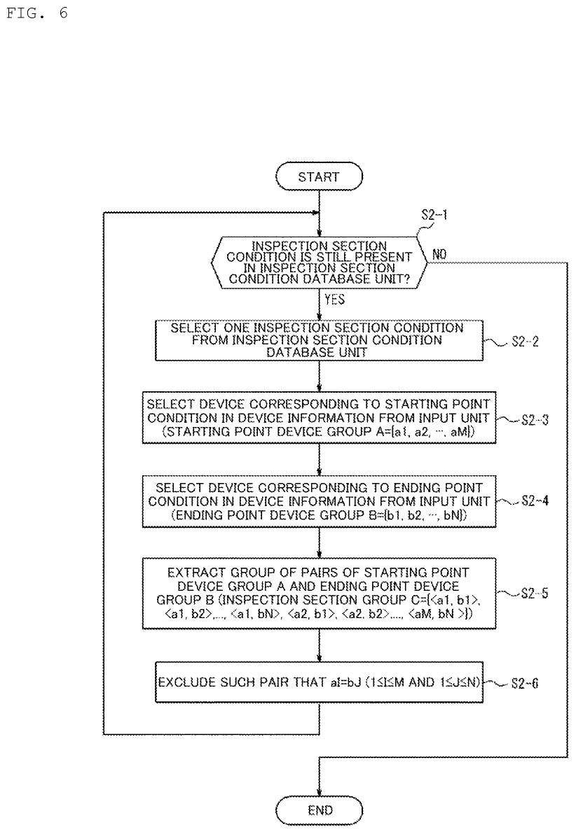

In step S2, the inspection section search unit 33 retrieves the device information 41 read in step S1 using the starting point condition and the ending point condition stored in the inspection section condition database unit 32 as a search formula according to such a flow as illustrated in FIG. 6.

In step S2-1, the inspection section search unit 33 determines whether the condition of the inspection section is still present in the inspection section condition database unit 32. If not present, the inspection section search unit 33 ends the processing of step S2. If present, in step S2-2, the inspection section search unit 33 selects one inspection section condition from the inspection section condition database unit 32. In step S2-3, the inspection section search unit 33 selects the devices 11 corresponding to the starting point condition in the device information 41 from the input unit 31 as a starting point device group A. Here, starting point device group A={a1, a2,, . . . aM}. In step S2-4, the inspection section search unit 33 selects the devices 11 corresponding to the ending point condition in the device information 41 from the input unit 31 as an ending point device group B. Here, ending point device group B={b1, b2, . . . , bN}. In step S2-5, the inspection section search unit 33 extracts a group of pairs of the starting point device group A and the ending point device group B as an inspection section group C. In the set theory, this processing corresponds to the “Cartesian product set” of A and B. That is, inspection section group C={<a1, b1>, <a1, b2>, . . . , <a1, bN>, <a2, b1>, <a2, b2>, . . . , <aM, bN>}. In step S2-6, the inspection section search unit 33 excludes such a pair that aI=bJ. Here, 1≤I≤M and 1≤J≤N.

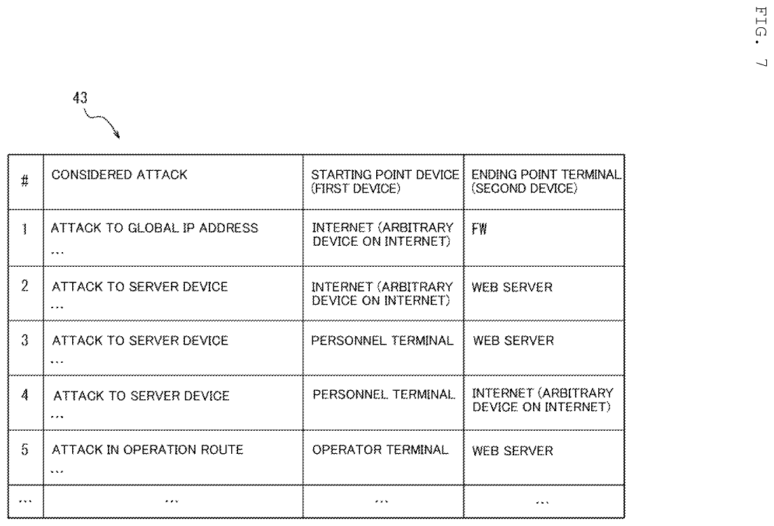

Such an inspection section group as illustrated in FIG. 7 is obtained as the result 43. The item of “attack to be considered” may not be included in the result 43.

In step S3, the output unit 34 outputs such a result 43 as illustrated in FIG. 7 in a format that a user can understand such as an electronic file or a console output screen.

According to the present embodiment, since an inspection section is selected automatically on the basis of a specific condition, effective security inspection in which an inspection target is narrowed down to a necessary section can be performed in a target system. That is, a user without special knowledge can narrow down the target route of security inspection. As a result, the efficiency of security inspection can be increased.

According to the present embodiment, by grouping a group of “routes” having a common combination of a starting point and an ending point as a section, it is possible to reduce the number of inspection targets and increase the efficiency of security inspection. Moreover, by narrowing down the section according to the starting point condition and the ending point condition, it is possible to further reduce the number of inspection targets and further increase the efficiency of security inspection.

According to the present embodiment, in cases where the device 11 such as a public server is attacked from an operator terminal infected with a virus by a targeted attack via an internal network, it is possible to examine vulnerability by security inspection.

The present invention is not limited to the above-described embodiment. For example, a plurality of functional blocks described in the block diagram may be integrated or one functional block may be divided. Instead of executing a plurality of steps of processing described in the flowchart in a time-series manner according to the described order, the plurality of steps of processing may be executed in parallel or a different order depending on the processing ability of a device that executes the processing or as necessary. Besides this, the present invention may be changed without departing from the spirit of the present invention.

For example, the condition data 42 stored in the inspection section condition database unit 32 may be data defining at least any one of the starting point condition and the ending point condition. That is, at least the starting point condition may be defined in the condition data 42 as long as the inspection target section is narrowed down by the starting point. At least the ending point condition may be defined in the condition data 42 as long as the inspection target section is narrowed down by the ending point.

When the functions of the inspection section search unit 33 are realized by software, the condition data 42 or the inspection section condition database unit 32 may be omitted as long as a logic for determining such a condition as defined in the condition data 42 in the above-described embodiment is incorporated in a program in which the processing corresponding to the functions is described. When the functions of the inspection section search unit 33 are realized by hardware, the condition data 42 or the inspection section condition database unit 32 may be omitted as long as a logic for determining such a condition as defined in the condition data 42 in the above-described embodiment is incorporated in a dedicated circuit that executes the processing corresponding to the functions.

### REFERENCE SIGNS LIST

10 Network system
11 Device
20 Inspection assistance device
21 Processing unit
22 Storage unit
23 Interface unit
31 Input unit
32 Inspection section condition database unit
33 Inspection section search unit
34 Output unit
41 Device information
42 Condition data
43 Result

1. An inspection assistance device that performs communication from a device serving as a starting point of an inspection section to a device serving as an ending point of the inspection section and assists in security inspection for examining security of the inspection section, the inspection assistance device comprising: an input unit that acquires device information of each of a plurality of devices that can communicate with each other; an inspection section condition database unit that stores condition data that defines at least one of a starting point condition which is a condition of the device serving as the starting point and an ending point condition which is a condition of the device serving as the ending point; and an inspection section search unit that compares the device information acquired by the input unit with the condition data stored in the inspection section condition database unit to extract one or more combinations of a first device serving as the starting point and a second device serving as the ending point from the plurality of devices.

2. The inspection assistance device according to claim 1, wherein the condition data is data that defines one or more combinations of the starting point condition and the ending point condition, and the inspection section search unit extracts a combination of a device in which the device information satisfies the starting point condition included in one of the combinations defined in the condition data and a device in which the device information satisfies the ending point condition included in the combination defined in the condition data from the plurality of devices as at least one of the combinations of the first device and the second device.

3. The inspection assistance device according to claim 2, wherein the condition data defines a combination of a condition that a device is used for designated use and a condition that a device performs communication for the designated use with a device used for the designated use as one of the combinations of the starting point condition and the ending point condition.

4. The inspection assistance device according to claim 2, wherein the condition data defines a combination of a condition that a device transmits a packet including designated data and a condition that a device receives a packet including the designated data as one of the combinations of the starting point condition and the ending point condition.

5. An inspection assistance method for performing communication from a device serving as a starting point of an inspection section to a device serving as an ending point of the inspection section and assisting in security inspection for examining security of the inspection section, the inspection assistance method comprising: acquiring device information of each of a plurality of devices that can communicate with each other; and comparing the device information with condition data that defines at least one of a starting point condition which is a condition of the device serving as the starting point and an ending point condition which is a condition of the device serving as the ending point to extract one or more combinations of a first device serving as the starting point and a second device serving as the ending point from the plurality of devices.

6. An inspection assistance program for performing communication from a device serving as a starting point of an inspection section to a device serving as an ending point of the inspection section and assisting in security inspection for examining security of the inspection section, the inspection assistance program causing a computer to execute: acquiring device information of each of a plurality of devices that can communicate with each other; and comparing the device information with condition data that defines at least one of a starting point condition which is a condition of the device serving as the starting point and an ending point condition which is a condition of the device serving as the ending point to extract one or more combinations of a first device serving as the starting point and a second device serving as the ending point from the plurality of devices.
